(19) United States
(12) Patent Application Publication
(10) Pub. No.: US 2016/0221204 A1
(43) Pub. Date: Aug. 4, 2016

(54) CUTTING HEADS FOR VINYL CUTTING DEVICE

(71) Applicant: JONG RAG JUN, Gimhae-si (KR)

(72) Inventor: JONG RAG JUN, Gimhae-si (KR)

(21) Appl. No.: 14/840,015

(22) Filed: Aug. 30, 2015

(30) Foreign Application Priority Data
Jan. 29, 2015 (KR) 10-2015-0014489

(51) Int. Cl. B26D 1/60; B26D 7/00; B26D 7/26

(52) U.S. Cl. CPC B26D 1/605; B26D 7/2628; B26D 7/0006

(57) ABSTRACT

The present invention relates to cutting heads for a vinyl cutting device, and more specifically cutting heads for a vinyl cutting device in which that a knife blade used in combination with an automated apparatus for a vinyl cutting can be positioned at a predetermined distance from the ground surface, thus preventing damage caused by contact with the ground surface.

Also, the present cutting device is characterized in that it comprises: a fastening part that is fixed by the fixing screw on the automated apparatus, a cutting wheel that is rotatably fixed by a shaft which passes through after being inserted into the fastening part a knife blade that is to attached to cut the vinyl on the side of the cutting wheel; and a wheel that is rotatably attached to the side of the cutting wheel and that is in contact with the vinyl or the ground surface, wherein the knife blade is positioned at a predetermined distance from the ground surface by the wheel, thus preventing damage caused by contact with the ground surface.

### CROSS-REFERENCE TO RELATED APPLICATION(S)

This application claims the benefit of Korean Patent Application No. 10-2015-0014489, filed on Jan. 29, 2015, which is hereby incorporated by reference herein in its entirety.

### BACKGROUND

1. Technical Field

The present invention relates generally to cutting heads for a vinyl cutting device, and more specifically cutting heads for a vinyl cutting device in which a knife blade used in combination with at automated apparatus for vinyl cutting can be positioned at a predetermined distance from the ground surface, thus preventing damage caused by contact with the ground surface.

2. Description of the Related Art

In general, packaging is performed after production of a finished product. In the case of a bulky product or a product that is frequently damaged, a protective vinyl is attached from the part state, or packing materials are covered and then supplied or assembled.

In order to increase productivity, a packaging apparatus for performing automatic packaging using a packaging material such as “Protective film taping device of the pipe” disclosed in Korean utility model registration no. 20-0378234 has been developed. In the case of the packaging material, however, as the component or the entire product are covered by the material, and thus there is a problem that unnecessary costs are spent.

Thus, a method of attaching a protective vinyl only to the necessary portion of the product is preferred, and in the case of small parts, a method of attaching a sticker is preferred.

Further, in the case of large products, it is difficult for an operator to manually cut having a large area, and so an automated apparatus for vinyl cutting has been developed and used.

However, it is difficult to expect a high quality of cutting due to the absence of a specialized cutting tool. In particular, when a cutting head having a knife blade for cutting the vinyl moves, there is a problem in that light vinyl is easily flying or contacted with a knife blade, and thus the vinyl is incorrectly cut.

In addition, when the vinyl is thin, there was a problem that the vinyl is not effectively cut, depending on the presence of foreign materials or the smoothness of the working bench.

### CITATION LIST

### Patent Literature

(Patent Literature 1) Korean utility model registration no. 20-0378234 entitled “Protective film taping device of the pipe”

### SUMMARY

The present invention has been made keeping in mind the above problems encountered in the prior arts, and an objective of the present invention is to provide a cutting head for a vinyl cutting device in which a vinyl is neither flying nor incorrectly cut when cutting the vinyl.

Another objective of the present invention is to provide a cutting head for vinyl cutting device capable of cutting the vinyl constantly, regardless of the presence of foreign materials or the smoothness of the working bench.

In order to accomplish the above-mentioned objectives, the present invention provides a cutting head for a vinyl cutting device characterized in that the cutting head comprises: a fastening part that is fixed by the fixing screw in the automated apparatus; a cutting wheel that is rotatably fixed by a shaft which passes through after being inserted into the fastening part; a knife blade that is attached to cut the vinyl on the side of the cutting wheel; and a wheel that is rotatably attached to the side of the cutting wheel and that is in contact with the vinyl or the ground surface, wherein the knife blade is positioned at a predetermined distance by the wheel from the ground surface, thus preventing damage caused by contact with the ground surface.

Also, the cutting head of the present invention is characterized in that it further comprises a pivoting hole that passes through the cutting wheel and that is in the form of a curve with a predetermined length (circumference) around a shaft, and a pivoting pin that is inserted in the pivoting hole and fixed to the fastening part, in which the rotation angle of the cutting wheel that rotates around the shaft is limited by the pivoting hole with a predetermined length (circumference) and the pivoting pin that passes through the pivoting hole.

Further, the cutting head of the present invention is characterized in that it further comprises a rotation adjustment screw contacting with the lower end of the fastening part when the cutting wheel is screw-connected with the rotation adjustment screw hole formed on the upper part of the cutting wheel and then rotated on one side, wherein the maximum rotation angle of the cutting wheel which rotates in one side is limited depending on the protruding height of the rotation adjustment screw.

Further, the knife blade is characterized in that it is removably and rotatably connected with a cutting wheel via a knife blade fixing screw.

Further, the cutting head of the present invention is characterized in that it further comprises a pressurization section for elastically supporting the knife blade which is rotated around the knife blade fixing screw.

Further, the cutting head of the present invention is characterized in that it comprises an elastic body which is inserted into the insertion hole fur the elastic body formed on the cutting wheel, and a pressurization member for transferring the elastic force of the elastic body to the knife blade.

The pressurization section is characterized in that it further comprises a pressure adjusting screw that is screw-connected to the insertion hole of the elastic body, the elastic force of the elastic body being adjusted by rotating the pressure adjusting screw.

As described above, the cutting head for vinyl cutting device according to the present invention has advantages in that the vinyl is neither flying nor incorrectly cut when cutting the vinyl.

Moreover, the cutting head for vinyl cutting device according to the present invention can cut the vinyl constantly, regardless of the presence of foreign materials or the smoothness of the working bench.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view showing the vinyl cutting device to which the cutting head for the vinyl cutting device according to the present invention is attached.

FIG. 2 and FIG. 3 are views showing the cutting head for the vinyl cutting device according to the present invention.

FIGS. 4 through 6 are exploded views showing the cutting head for the vinyl cutting device according to the present invention.

FIG. 7 and FIG. 8 are views illustrating how the cutting wheel of the cutting head for the vinyl cutting device according to the present invention is rotated.

FIG. 9 is as view showing the pressurization part of the cutting head for the vinyl cutting device according to the present invention.

FIG. 10 and FIG. 11 are views illustrating how the cutting wheel of the cutting head for the vinyl cutting device according to the present invention is rotated.

### DETAILED DESCRIPTION

The above and other objects, features and advantages of the present invention will be more dearly understood from the following detailed description taken in conjunction with the accompanying drawings, in which:

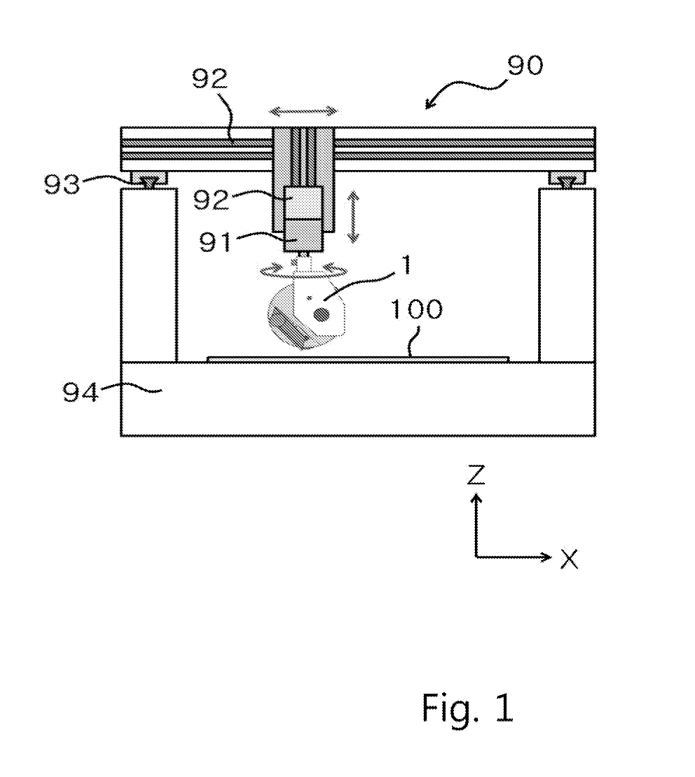

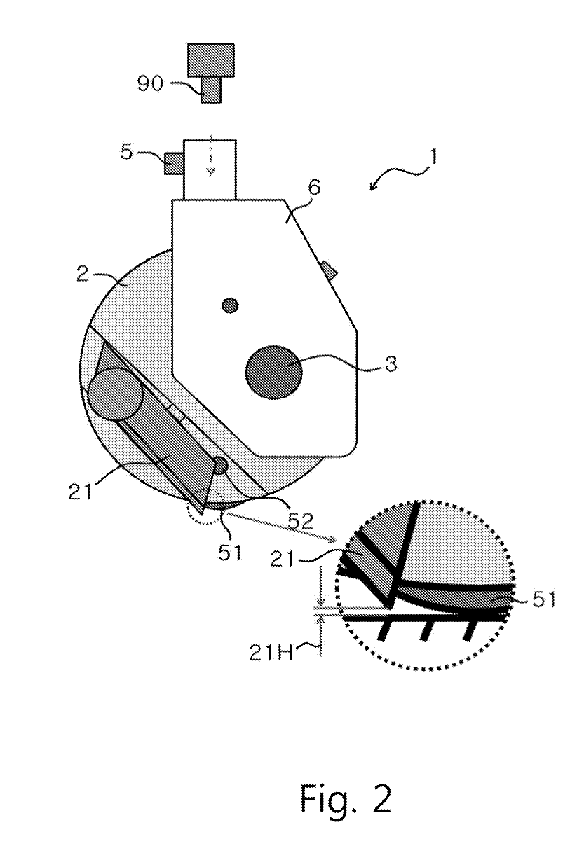

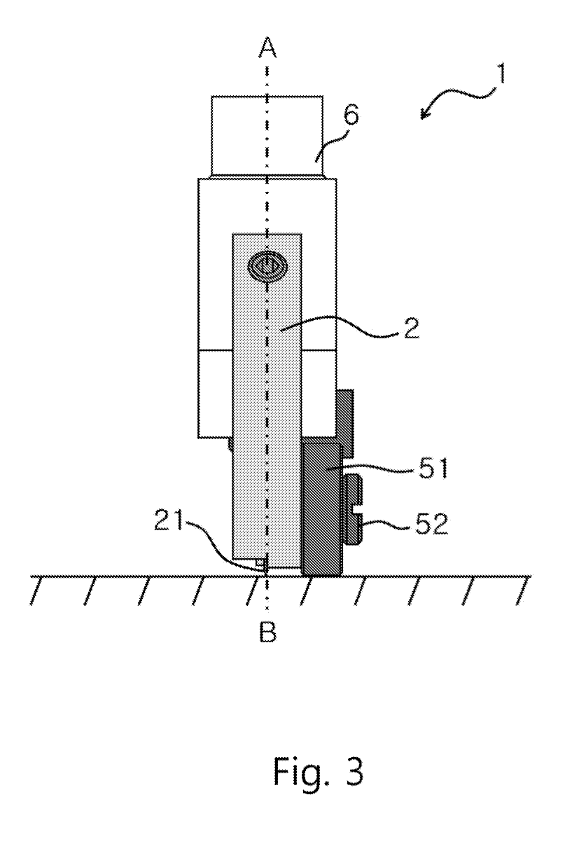

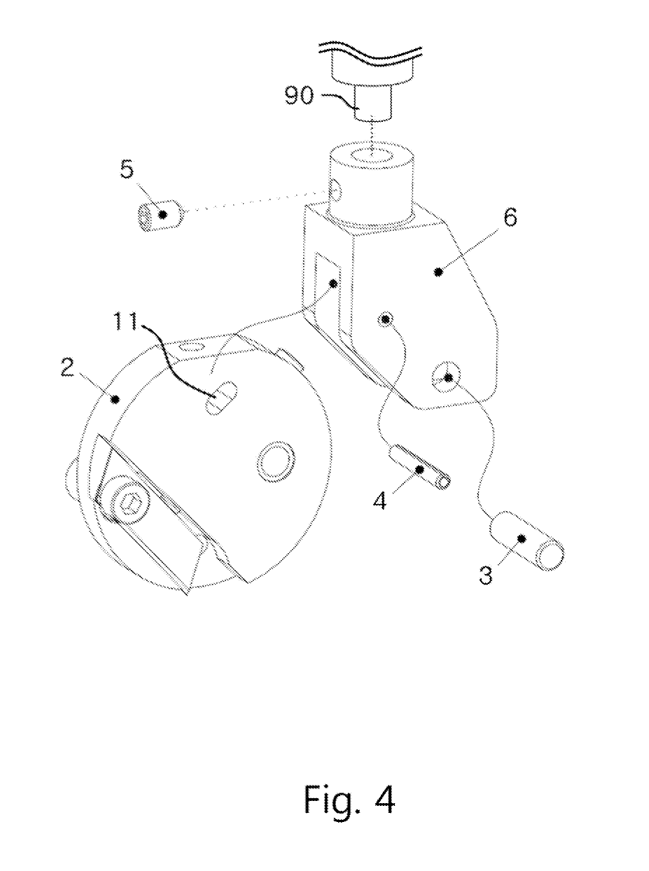

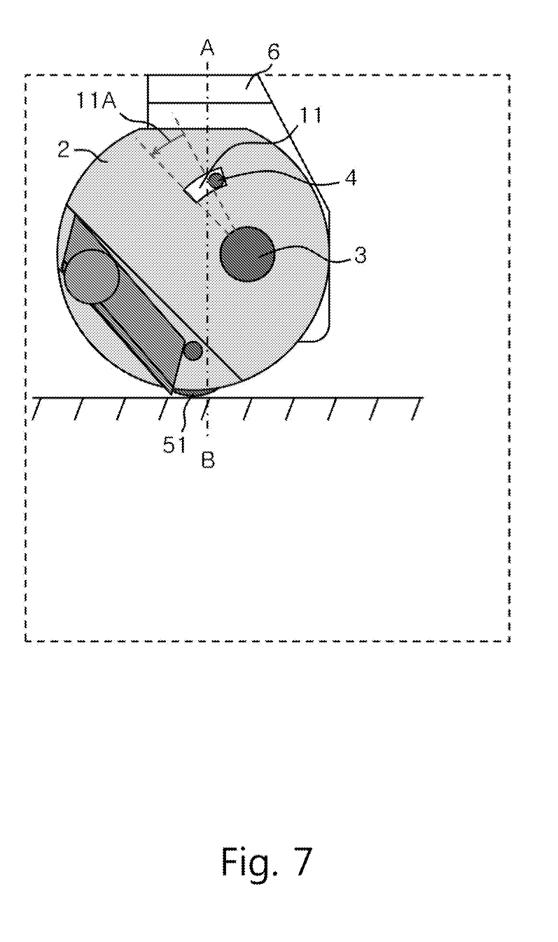

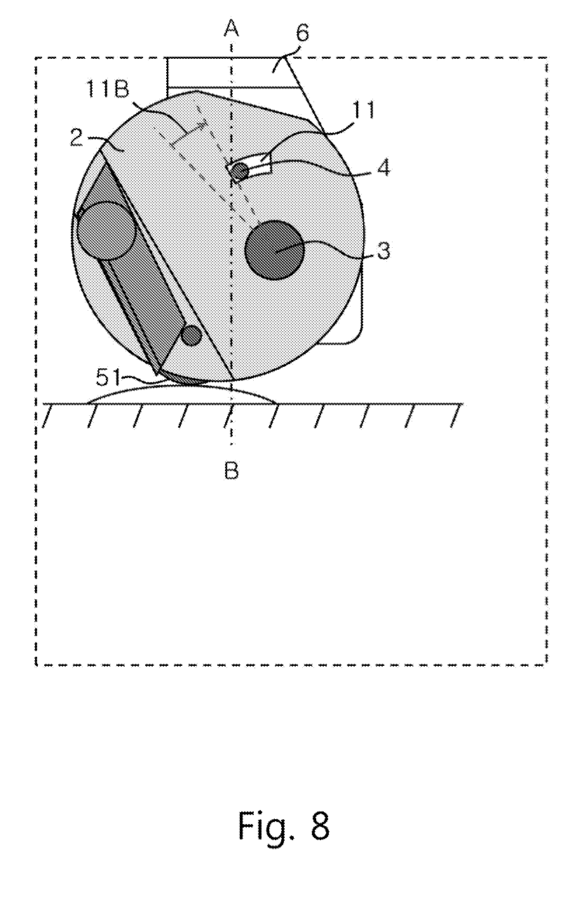

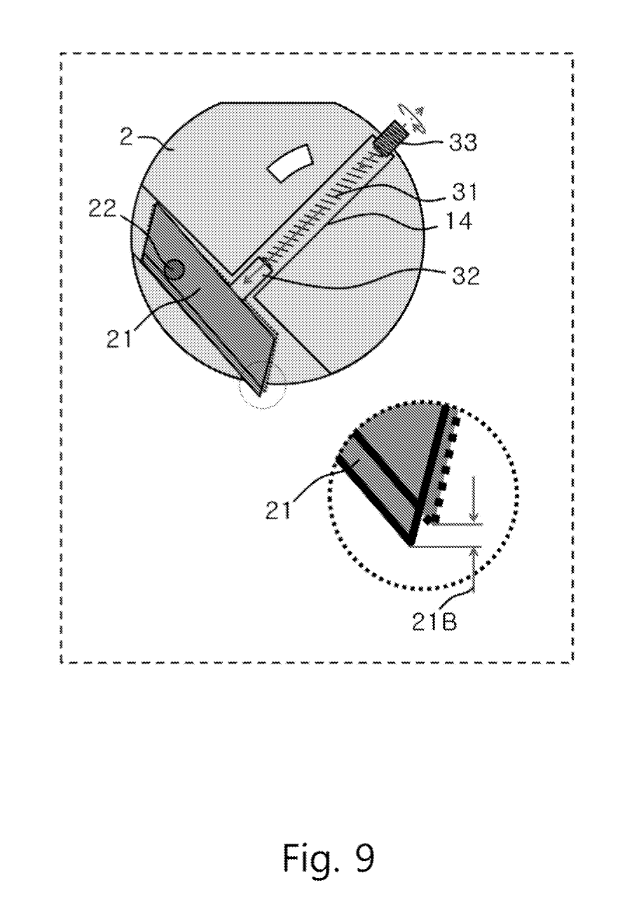

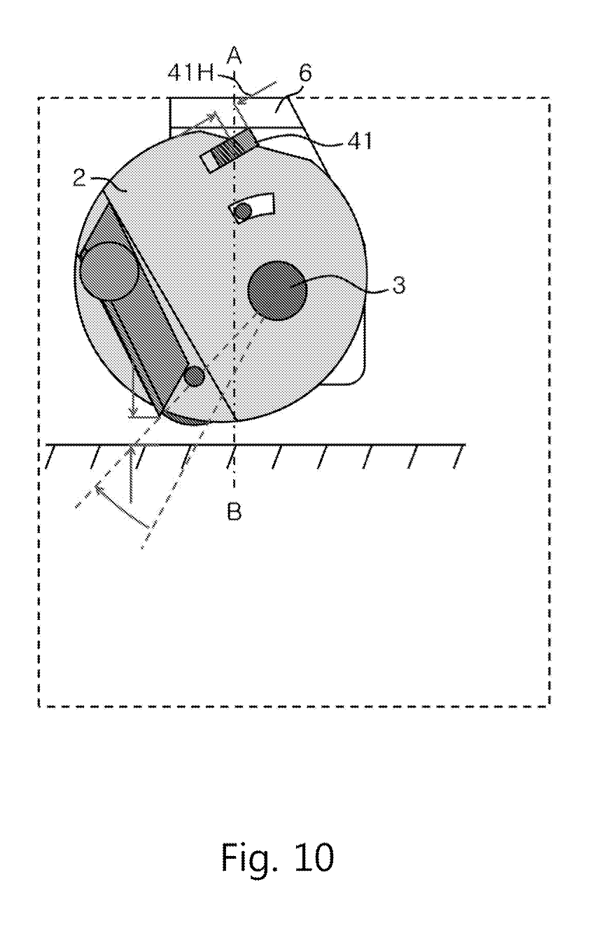

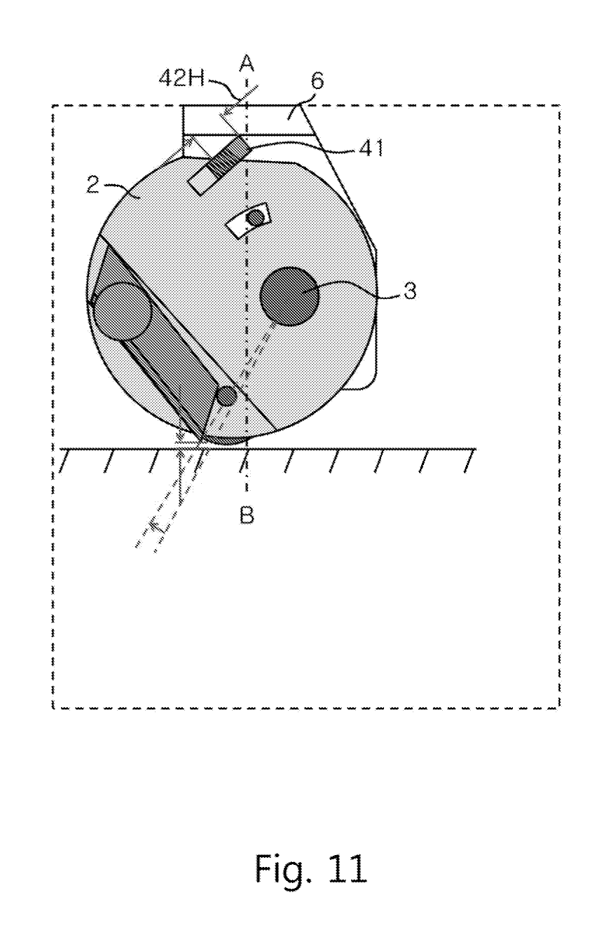

FIG. 1 is a view showing the vinyl cutting device to which the cutting head for vinyl cutting device according to the present invention is attached. FIG. 2 and FIG. 3 are views showing the cutting head for the vinyl cutting device according to the present invention, FIGS. 4 through 6 are exploded views showing the cutting head for the vinyl cutting device according to the present invention. FIG. 7 and FIG. 8 are views illustrating how the cutting wheel of the cutting head for the vinyl cutting device according to the present invention is rotated. FIG. 9 is a view showing the pressurization section of the cutting head for the vinyl cutting device according to the present invention. FIG. 10 and FIG. 11 are views illustrating how the cutting wheel of the cutting head for the vinyl cutting device according to the present invention is rotated.

FIG. 1 is a view showing the vinyl cutting device to which the cutting head for the vinyl cutting device according to the present invention is attached. The vinyl cutting device is configured such that it comprises a working bench 95 that houses the vinyl 100 to be cut; X-axis transfer part 93, Y-axis transfer part 94 and Z-axis transfer part 92 for X-, Y- and Z-axis transferring the cutting head 1 for the vinyl cutting device according to the present invention in the upper part of the working bench 95; and a rotation servomotor 91 for Z-axis rotating the cutting head 1 for the vinyl cutting device.

Also, the cutting head 1 for the vinyl cutting device according to the present invention is attached to the rotation shaft of the rotation servomotor 91 and rotated along the cutting direction.

The X-axis transfer part 93, Y-axis transfer part 94 and Z-axis transfer part 92 further include a LM guide, a servomotor, a ball screw and the like so that each of them transfers in the axis direction, but the technical configuration of the three-axis transfer is a known technique and so the detailed description thereof is omitted.

The following illustrates that the cutting head 1 for the vinyl cutting device according to the present invention is fastened to the automated apparatus 90.

FIG. 2 and FIG. 3 are views showing the cutting head for the vinyl cutting device according to the present invention. This cutting head 1 is used in combination with the automated apparatus 90 for vinyl cutting. The cutting head 1 is configured such that it includes a fastening part 6 that is fixed by the fixing screw 5 in the automated apparatus 90; a cutting wheel 2 that is rotatably fixed by a shaft 3 which passes through after being inserted into the fastening part 6; a knife blade 21 that is attached to cut the vinyl on the side of the cutting wheel 2; and a wheel 51 that is rotatably attached to the side of the cutting wheel 2 and that is in contact with the vinyl or the ground surface.

Further, a knife blade 21 is positioned at a predetermined distance (21H) by a wheel 51 from the ground surface, thus preventing damage caused by contact with the wound surface.

Further, the predetermined distance (21H) may vary depending on the thickness of the vinyl to be cut. When the vinyl has a thickness of 0.05 mm, the distance (21H) between the knife blade 21 and the wheel 51 is preferably controlled so as to be spaced apart by 0.01 mm.

In accordance with various embodiments, the cutting head for a vinyl cutting device according to the present invention may include one or more selected from the group consisting of: a rotation limiting section for limiting the rotation angle of the cutting wheel 2 that rotates around a shaft 3 of the fastening part 6; a rotation adjustment section for limiting a maximum rotation height of the cutting wheel 2; a pressurization section for pressurizing a knife blade with a predetermined force; and a knife blade-attachable/detachable section for attaching and detaching the knife blade. The description thereof will be given in more detail below.

FIGS. 4 through 6 are exploded views illustrating embodiments in which the cutting head for the vinyl cutting device according to the present invention includes all of the rotation limiting section, the rotation adjustment section, the pressurization section and the knife blade-attachable/detachable section.

More specifically, as shown in FIG. 4, the fastening part 6 that is fixed by the fixing screw 5 in the automated apparatus 90 is in a form in which the lower part and both side faces are opened. The cutting wheel 2 is inserted in the fastening part 6 and then rotatably fixed by a shaft 3.

Further, the rotation limiting section for limiting a rotation angle of the cutting wheel 2 is in the form of a curve with a predetermined length (circumference) mound the shaft 3 and includes a pivoting hole 11 that passes through the cutting wheel 2 and a pivoting pin 4 that is inserted in the pivoting hole 11 and fixed to the fastening part 6.

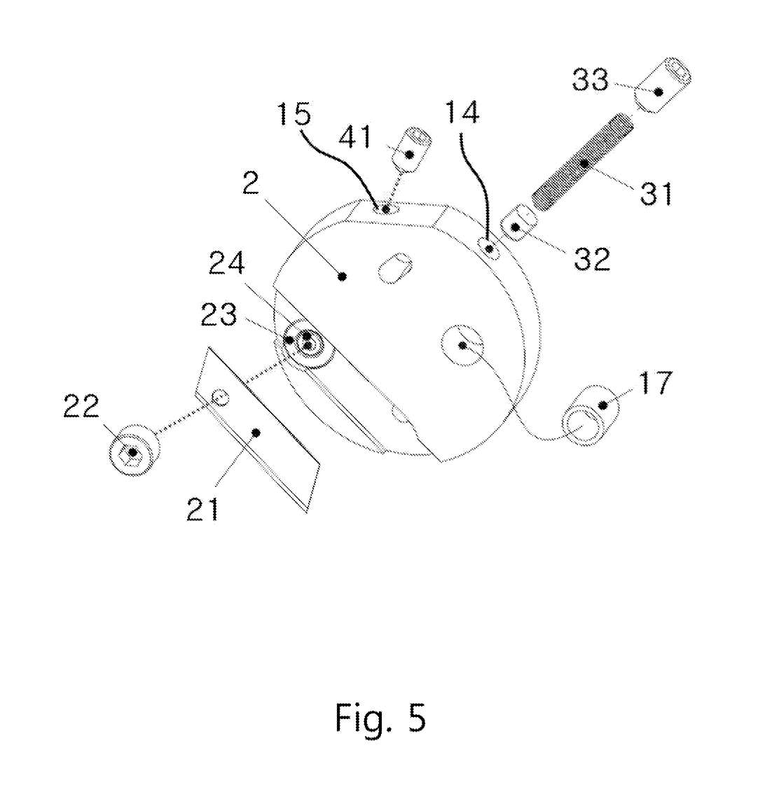

As shown in FIG. 5, the rotation adjustment section for limiting a maximum rotation height of the cutting wheel 2 is positioned in an upper part of the cutting wheel 2. The rotation adjustment section is configured such that it includes a rotation adjustment screw hole 15 formed on the upper part of the cutting wheel 2, and a rotation adjustment screw 41 that is screw-connected to the rotation adjustment screw hole 15.

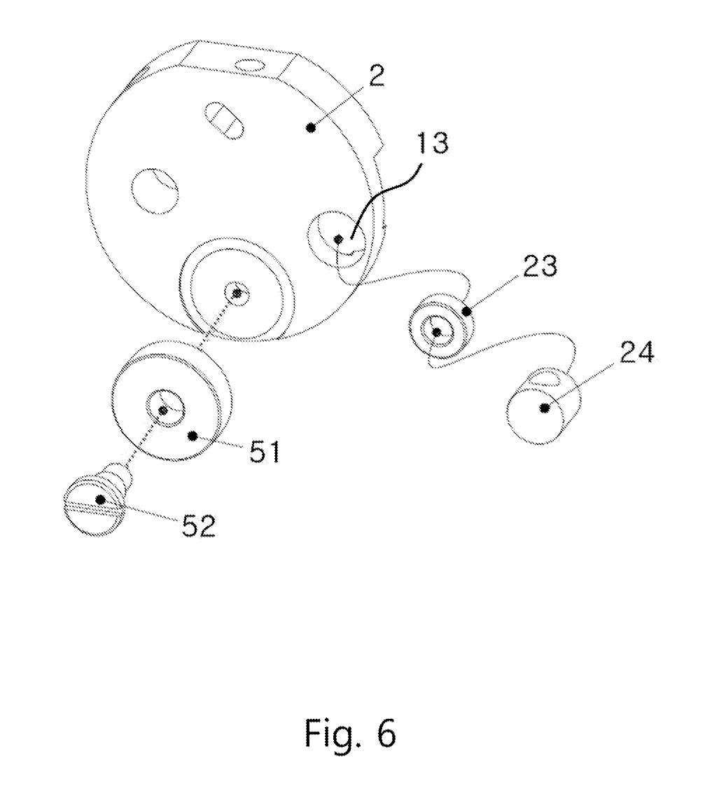

Further, as shown in FIG. 5 and FIG. 6, a knife blade-attachable/detachable section for attaching and detaching the knife blade 21 is positioned in the cutting wheel 2. The knife, blade-attachable/detachable section is configured to include a knife blade fixing screw 22 for fixing the knife blade and a knife blade fixing shaft 24 for attaching the knife blade fixing screw 22. The knife blade attachable/detachable section may further include a knife blade bearing 23 for reducing the rotation resistance of the knife blade combined by the knife blade fixing screw 22.

In addition, it may further include a shaft bearing 17 for reducing a rotation resistance of the cutting wheel 2. The cutting head for the vinyl cutting device according to the present invention presses and cuts the vinyl using the dead-weight. Thus, the cutting head is most preferably configured to include a knife blade bearing 23 as it is easy to continuously press against the vinyl using the dead-weight when the resistance to the rotation is low.

Further, the wheel 51 is combined via a wheel fixing screw 52 on a side of the cutting wheel 51 and it is configured to rotate a wheel fixing screw 52 along a rotation axis. The wheel 51 may be in the form in which a bearing for reducing a rolling resistance is incorporated.

FIGS. 7 through 11 are intended to illustrate the rotation adjustment section, the pressurization section and the rotation adjustment section in more detail.

FIGS. 7 and 8 are views illustrating how the cutting wheel 2 of the cutting head for the vinyl cutting device according to the present invention is rotated and that the rotation of the cutting wheel 2 is limited by the rotation limiting section.

More specifically, as shown in FIG. 7, the cutting wheel 2 is rotated as shown by 11A until the wheel 51 is in contact with the ground surface by the dead-weight or until the pivoting pin 4 is in contact with one side of the pivoting hole 11 formed on the cutting wheel 2.

In other words, it is possible to press and cut the vinyl using the dead-weight so that the vinyl is not flying (floating) when cutting. Thus, it is possible to prevent incorrect cutting.

Also, as shown in FIG. 8, when foreign materials exist on the lower part of the cutting wheel 2 or the working bench is uneven or coarse and there are projections/recessions, as the cutting wheel 2 is rotated around the shaft 3 as shown by 11b, the vinyl can be constantly cut irrespective of the presence of foreign materials or the smoothness of the working bench.

The maximum angle along which the cutting wheel 2 is rotated such that the cutting wheel 2 can be rotated until the pivoting pin 4 is in contact with the other side of the pivoting pin 4.

In other words, the pivoting pin 4 of the rotation limiting section limits rotation of the cutting wheel 2 to an angle of contact with one side of the pivoting hole 11.

FIG. 9 is a view showing the pressurization section of the cutting head for the vinyl cutting device according to the present invention. The elastic body 31 which is inserted in the elastic insertion hole 14 formed on the cutting wheel 2 applies a predetermined elastic force to the knife blade via the pressurization member 32.

Thus, the knife blade 21 that is rotatably fixed by the knife blade fixing screw 22 is rotated in a predetermined amount as shown by 21B. Thereafter, the knife blade is pressed constantly with a predetermined elastic force so as to be returned to the initial position.

The pressure adjustment screw 33 can be further included in the upper part of the insertion hole 14 of the elastic body. The elastic body 31 is further pressurized by rotating the pressure adjustment screw 33, or vice versa.

Further, the height of the knife blade can be finely adjusted through the change of the elastic force of the elastic body 31 that is changed by rotating the pressure adjusting screw 33.

FIG. 10 and FIG. 11 are views illustrating the rotation adjustment section fur adjusting the maximum rotation height of the cutting wheel of the cutting head for the vinyl cutting device according to the present invention.

As described above, the maximum rotation height of the cutting wheel 2 can be adjusted using the rotation adjustment section only until the pivoting pin is in contact with one side of the pivoting hole.

More specifically, the maximum rotation height can be adjusted by winding or unwinding the rotation adjustment screw 41 or by adjusting the height at which the upper part of the cutting wheel 2 is protruded.

For example, when the rotation adjustment screw 41 protruding at the height of 41H is unwound as shown in FIG. 10 or when rotated and unwound at the height of 42H as shown in FIG. 11, the rotation adjustment screw 41 is further protruded and so the spacing between the lower part of the fastening part 6 becomes narrow, and the rotation angle of the cutting wheel 2 that is rotated around the shaft 3 becomes narrower.

Additionally, the actual spacing between the blade and the ground surface becomes narrow in proportion thereto.

As described above, preferred embodiments of the present invention have been described with reference to the accompanying drawings. However, those skilled in the art will appreciate from these descriptions that various modifications, additions and substitutions can be made to the invention without departing from the scope and spirit of the invention. Accordingly, the scope of the present invention should be construed by the claims and considered to include many modified examples.

What is claimed is:

1. A cutting head for a vinyl cutting device characterized in that the cutting head comprises: a fastening part that is fixed by the fixing screw in the automated apparatus; a cutting wheel that is rotatably fixed by a shaft which passes through after being inserted into the fastening part; a knife blade that is attached to cut the vinyl on the side of the cutting wheel; and a wheel that is rotatably attached to the side of the cutting wheel and contacted with the vinyl or the ground surface, wherein the knife blade is positioned at a predetermined distance by the wheel from the ground surface, thus preventing damage caused by contact with the ground surface.

2. The cutting head for the vinyl cutting device of claim 1 wherein the cutting head further comprises a pivoting hole that passes through the cutting wheel and that is in the form of a curve with a predetermined length (circumference) around a shaft, and a pivoting pin that is inserted in the pivoting hole and fixed to the fastening part, in which the rotation angle of the cutting wheel that rotates around the shaft is limited by the pivoting hole with a predetermined length (circumference) and the pivoting pin that passes through the pivoting hole.

3. The cutting head for vinyl cutting device of claim 1 wherein the cutting head further comprises a rotation adjustment screw contacting with the lower end of the fastening part when the cutting wheel is screw-connected with the rotation adjustment screw hole formed on the upper part of the cutting wheel and then rotated on one side, wherein the maximum rotation angle of the cutting wheel which rotates in one side is limited depending on the protruding height of the rotation adjustment screw.

4. The cutting head for vinyl cutting device of claim 1 wherein the knife blade is detachably/attachably and rotatably connected with a cutting wheel via as knife blade fixing screw.

5. The cutting head for the vinyl cutting device of claim 4 wherein the cutting head further comprises a pressurization section for elastically supporting the knife blade which is rotated around the knife blade fixing screw.

6. The cutting head for the vinyl cutting device of claim 5 wherein the cutting head to comprises an elastic body which is inserted into the insertion hole of the elastic body formed on the cutting wheel, and a pressurization member for transferring the elastic force of the elastic body to the knife blade.

7. The cutting bead for the vinyl cutting device of claim 6 wherein the pressurization section further comprises a pressure adjusting screw that is screw-connected to the insertion hole for the elastic body, the elastic force of the elastic body being adjusted by rotation the pressure adjusting screw.
